(19) United States
(12) Patent Application Publication
(10) Pub. No.: US 2018/0081484 A1
(43) Pub. Date: Mar. 22, 2018

(54) INPUT METHOD FOR MODELING PHYSICAL OBJECTS IN VR/DIGITAL

(71) Applicant: Sony Interactive Entertainment Inc., Tokyo (JP)

(72) Inventor: Glenn Black, San Mateo, CA (US)

(21) Appl. No.: 15/270,230

(22) Filed: Sep. 20, 2016

(51) Int. Cl. G06F 3/041; G06T 19/00; G06F 3/01; G06T 17/00

(52) U.S. Cl. CPC G06F 3/0416; G06T 17/00; G06F 3/011; G06T 19/006

(57) ABSTRACT

A method, apparatus, and compute storage in which signals are received from a touch screen against which a 3D object is juxtaposed, the signals being generated by tracing the periphery of the object on the touch screen at consecutive coordinates in two dimensions (2D). A dimension of the 3D object is also determined based on which coordinates the periphery was traced against. Resultant 2D trace signals are output to a 3D modeling module along with the dimension of the 3D object, which uses the trace signals and dimension to generate a 3D image of the 3D object.

### FIELD

The application relates generally to input methods for modeling physical objects in virtual reality (VR)/Digital applications.

### BACKGROUND

Digital applications such as but not limited to virtual reality (VR) and augmented reality (AR) require reproducing, on VR/AR displays, 3D images of real world objects. As understood herein, creating such images typically entails prior/expert knowledge of 3D modeling software. As further understood herein, 3D image scanning, while useful for creating 3D images, is both time consuming and not readily amenable to correlating the image to real world dimensions of the object, i.e., an object can be scanned but it is not necessarily straightforward to tie the scanned image to its size in the real world, so that the image of the object can be rendered more realistically in VR/AR applications.

### SUMMARY

Accordingly, present principles permit creating 3D images without expert knowledge of 3D modeling software in a way that directly correlates the image to the dimensions of the object in the real world.

A touch screen and stylus device may be used to allow tracing outlines of physical parts. This creates high accuracy dimensioned data for use in computer aided design (CAD) software and/or video game environments.

In one aspect, a device has a computer memory that is not a transitory signal and that includes instructions executable by a processor to receive signals from a touch screen representing a two dimensional (2D) trace of a 3D object on the touch screen. The signals indicate touch screen coordinates. The instructions are executable to, using the touch screen coordinates indicated by the signals, identify at least one dimension of the 3D object. The instructions are further executable to output signals representing the 2D trace and the dimension to a 3D modeling module for generating a 3D image of the 3D object based on the 2D trace and the dimension.

In some example, the instructions may be executable to output the 2D trace to the 3D modeling module as an input 2D sketch to the 3D modeling module.

In non-limiting implementations, the touch screen may be an analog resistive touch screen, a capacitive touch screen, a scanning infrared (IR) touch screen, a surface acoustic wave (SAW) touch screen, an infrared grid touch screen, an infrared acrylic projection touch screen, an optical imaging touch screen, a dispersive signal technology touch screen, or an acoustic pulse recognition touch screen. If desired, the touch screen may include a controller embodied in a printed circuit board assembly.

In another aspect, a method includes receiving signals from a touch screen at consecutive coordinates in two dimensions (2D), and using the coordinates, identifying at least one dimension of a 3D object. The method also includes outputting, to a 3D modeling module, 2D trace signals based on the consecutive coordinates, and outputting to the 3D modeling module the dimension to enable the 3D modeling module to generate a 3D image of the 3D object.

In another aspect, an apparatus includes at least one processor and at least one storage accessible to the at least one processor and including instructions executable by the processor for receiving trace signals from a touch screen with which a three dimensional (3D) object is juxtaposed. The trace signals represent a periphery of the 3D object and establish a 2D sketch of the 3D object. The instructions are executable for determining a dimension of the 3D object based on coordinates of the touch screen at which the trace signals are input to the touch screen, and outputting the 2D sketch and the dimension to a 3D image generation module.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a perspective view of a real world object being held over a touch screen for tracing the object on the touch screen;

FIG. 3 is a plan view of the touch screen showing the 2D tracing of the 3D object in broken lines for illustration; and

FIG. 4 is a flow chart of example logic.

### DETAILED DESCRIPTION

This disclosure relates generally to computer ecosystems including aspects of consumer electronics (CE) device networks such as but not limited to distributed computer game networks. A system herein may include server and client components, connected over a network such that data may be exchanged between the client and server components. The client components may include one or more computing devices including game consoles such as Sony PlayStation™, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Orbis or Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony Playstation (trademarked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

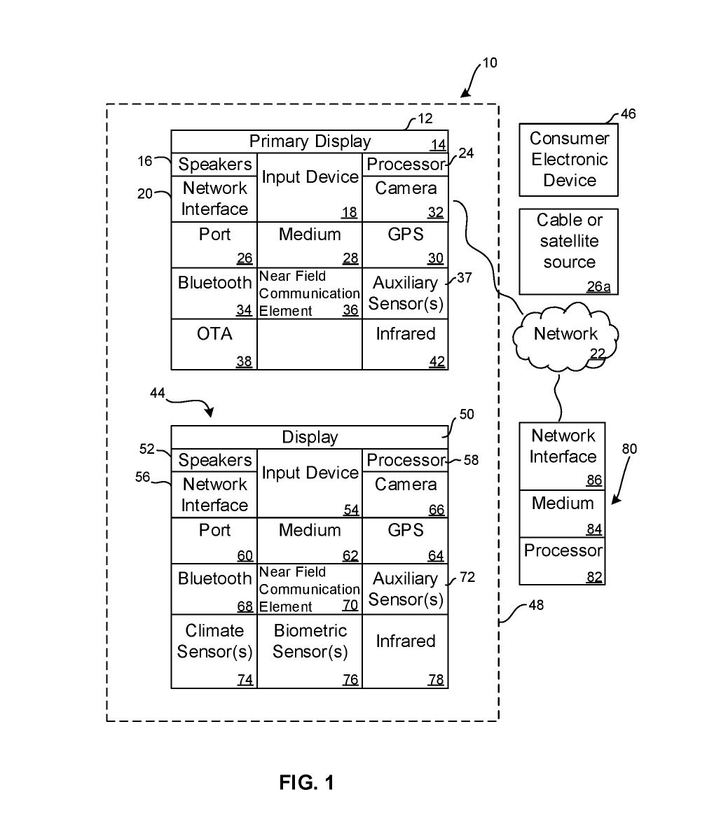

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a web cam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used. As alluded to above, the CE device 44/46 and/or the source 26a may be implemented by a game console. Or, one or more of the CE devices 44/46 may be implemented by devices sold under the trademarks Google Chromecast, Roku, Amazon FireTV.

In the example shown, to illustrate present principles all three devices 12, 44, 46 are assumed to be members of an entertainment network in, e.g., a home, or at least to be present in proximity to each other in a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVD 12, or it may be a more sophisticated device such as a tablet computer, a game controller communicating via wired or wireless link with a game console implemented by the second CE device 46 and controlling video game presentation on the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver. Typically, the server 80 includes multiple processors in multiple computers referred to as “blades”.

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

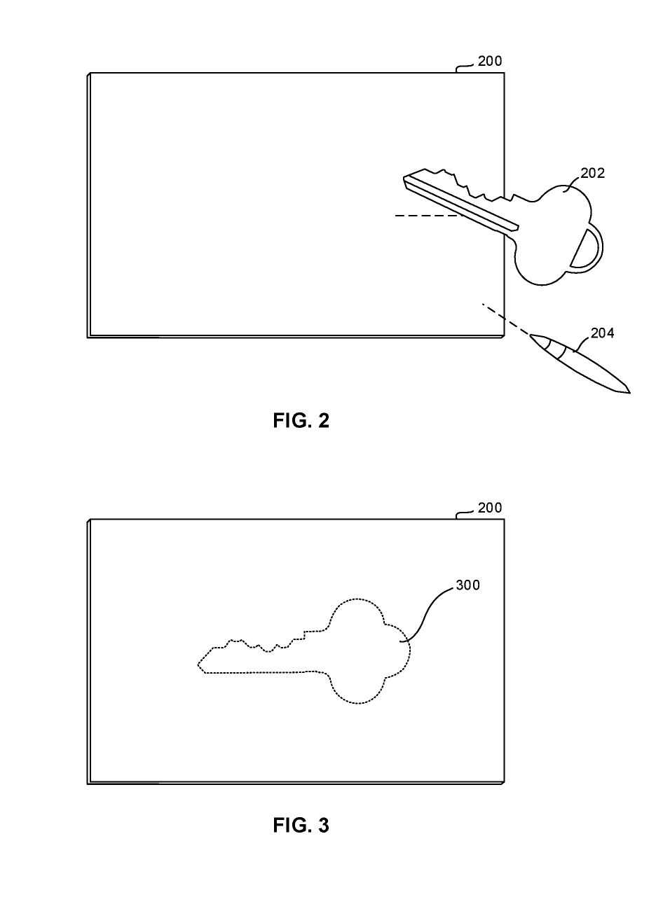

Turning to FIG. 2, a touch screen device 200, which may incorporate some or all of the components described in FIG. 1 as appropriate, is provided. In non-limiting implementations, the touch screen may be an analog resistive touch screen, a capacitive touch screen, a scanning infrared (IR) touch screen, a surface acoustic wave (SAW) touch screen, an infrared grid touch screen, an infrared acrylic projection touch screen, an optical imaging touch screen, a dispersive signal technology touch screen, or an acoustic pulse recognition touch screen. If desired, the touch screen may include a controller embodied in a printed circuit board assembly.

An outline of an object 202 such as a key may be drawn on the touch screen 200, e.g., by finger or using a stylus 204. FIG. 3 shows such an outline 300 (in broken lines to distinguish it from the real world object 202). Thus, it readily be appreciated that the touch screen outputs signals representing a two dimensional (2D) trace 300 of the 3D object 202. The trace outline 300 represents the periphery of the 3D object 202.

Furthermore, it will be appreciated that the signals indicate the consecutive touch screen coordinates over which the trace 300 was made. Since the touch screen processor knows the dimensions of its screen in terms of coordinates, the dimensions of the part of the 3D object 202 outlines on the touch screen, being essentially the same as those of the trace 300, can be readily identified by correlating the coordinates to the known distances by which they are separated from one another.

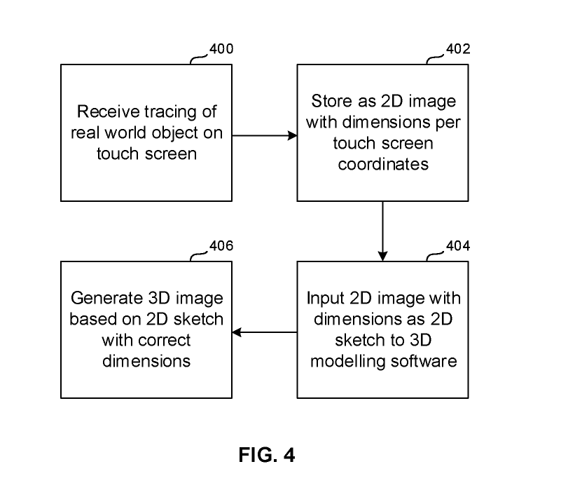

FIG. 4 illustrates principles above using a logic flow diagram. At block 400 the tracing 300 of the real world object 202 is received on the touch screen 200. The trace is stored at block 402 as a 2D image along with the dimensions of the trace as indicated by the coordinates of the touch screen over which the trace was made. The 2D trace essentially establishes a 2D sketch that may be input at block 404 along with the dimensions to a 3D modeling module for generating a 3D image of the 3D object based on the 2D trace and the dimension at block 406.

It will be appreciated that whilst present principals have been described with reference to some example embodiments, these are not intended to be limiting, and that various alternative arrangements may be used to implement the subject matter claimed herein.

What is claimed is:

1. Device comprising:
at least one computer memory that is not a transitory signal and that comprises instructions executable by at least one processor to:
receive signals from a touch screen representing a two dimensional (2D) trace of a 3D object on the touch screen;
the signals indicating touch screen coordinates;
using the touch screen coordinates indicated by the signals, identify at least one dimension of the 3D object; and
output signals representing the 2D trace and the at least one dimension to a 3D modeling module for generating a 3D image of the 3D object based on the 2D trace and the at least one dimension.

2. The device of claim 1, wherein the instructions are executable to output the 2D trace to the 3D modeling module as an input 2D sketch to the 3D modeling module.

3. The device of claim 1, wherein the touch screen is an analog resistive touch screen.

4. The device of claim 1, wherein the touch screen is a capacitive touch screen.

5. The device of claim 1, wherein the touch screen is a scanning infrared (IR) touch screen.

6. The device of claim 1, wherein the touch screen is a surface acoustic wave (SAW) touch screen or an infrared grid touch screen or an infrared acrylic projection touch screen or an optical imaging touch screen or a dispersive signal technology touch screen or an acoustic pulse recognition touch screen.

7. The device of claim 1, wherein the touch screen includes a controller embodied in a printed circuit board assembly.

8. Method comprising:
receiving signals from a touch screen at consecutive coordinates in two dimensions (2D);
using the coordinates, identifying at least one dimension of a 3D object;
outputting, to a 3D modeling module, 2D trace signals based on the consecutive coordinates; and
outputting to the 3D modeling module the at least one dimension to enable the 3D modeling module to generate a 3D image of the 3D object.

9. The method of claim 8, comprising:
holding the 3D object on the touch screen; and
tracing a periphery of the 3D object on the touch screen to generate the signals from at consecutive coordinates in two dimensions (2D).

10. Apparatus comprising:
at least one processor; and
at least one storage accessible to the at least one processor and comprising instructions executable by the at least one processor for:
receiving trace signals from a touch screen with which a three dimensional (3D) object is juxtaposed, the trace signals representing a periphery of the 3D object and establishing a 2D sketch of the 3D object;
determining a dimension of the 3D object based on coordinates of the touch screen at which the trace signals are input to the touch screen; and
outputting the 2D sketch and the dimension to a 3D image generation module.

11. The apparatus of claim 10, wherein the touch screen is an analog resistive touch screen.

12. The apparatus of claim 10, wherein the touch screen is a capacitive touch screen.

13. The apparatus of claim 10, wherein the touch screen is a scanning infrared (IR) touch screen.

14. The apparatus of claim 10, wherein the touch screen is a surface acoustic wave (SAW) touch screen or an infrared grid touch screen or an infrared acrylic projection touch screen or an optical imaging touch screen or a dispersive signal technology touch screen or an acoustic pulse recognition touch screen.

15. The apparatus of claim 10, wherein the touch screen includes a controller embodied in a printed circuit board assembly.

16. The apparatus of claim 10, wherein the instructions are executable to:
generate a 3D image of the object based on the 2D sketch and dimension.

17. The device of claim 1, comprising the touch screen.

18. The apparatus of claim 10, comprising the touch screen.
